(19) United States
(12) Patent Application Publication
(10) Pub. No.: US 2014/0015851 A1
(43) Pub. Date: Jan. 16, 2014

(54) METHODS, APPARATUSES AND COMPUTER PROGRAM PRODUCTS FOR SMOOTH RENDERING OF AUGMENTED REALITY USING ROTATIONAL KINEMATICS MODELING

(71) Applicant: Aaron Licata, San Ramon, CA (US)

(72) Inventor: Aaron Licata, San Ramon, CA (US)

(73) Assignee: NOKIA CORPORATION, Espoo (FI)

(21) Appl. No.: 13/548,875

(22) Filed: Jul. 13, 2012

(51) Int. Cl. G06T 5/00; G09G 5/377

(52) U.S. Cl. 345/611; 345/633

(57) ABSTRACT

An apparatus for facilitating smooth rendering of augmented reality may include a processor and memory storing executable computer program code that cause the apparatus to at least perform operations including determining an orientation of a media capturing device capturing a real-world object(s) in a field of view. The kinematics model is predefined with data specifying a manner to determine orientations of the media capturing device. The computer program code may further cause the apparatus to periodically receive information from a sensor(s). The information may indicate an orientation is changed to a different orientation responsive to detection of a change in rotational angular velocity of the media capturing device. The computer program code may further cause the apparatus to adjust data of the kinematics model based on the information from the sensor(s) to estimate a current orientation of the media capturing device. Corresponding methods and computer program products are also provided.

### TECHNOLOGICAL FIELD

An embodiment of the invention relates generally to user interface technology and, more particularly, relates to a method, apparatus, and computer program product for facilitating smooth rendering of augmented reality based in part on utilizing rotational kinematics modeling.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In some situations, mobile terminals may enhance the interaction that users have with their environment. Numerous use cases have developed around the concept of utilizing mobile terminals to enhance user interaction with their local area such as, for example, virtual tour guides and other mixed reality applications. Mixed reality involves the merging of real and virtual worlds. In some cases, mixed reality involves mixing real world image data with virtual objects in order to produce environments and visualizations in which physical and digital objects co-exist and potentially also interact in real time. Mixed reality includes augmented reality, which uses digital imagery to augment or add to real world imagery, and virtual reality, which simulates real world environments using computer simulation.

Augmented reality is a fast growing area, which is currently available on many mobile platforms (e.g., Symbian™, Android™, iPhone™, Windows Mobile™). The concept of augmented reality is to overlay graphics or information on a live video stream or a still image from a camera in a communication device. The graphics/information may be of any kind. In augmented reality graphics/information about the environment and objects in it may be stored and retrieved as an information layer on top of a view of the real world.

A common use of augmented reality is to overlay points of interest (POIs) on a video stream or still image. These POIs may be static information, like landmarks, for example or any information that may be geo-coded (e.g., contains a coordinate). In this regard, mobile augmented reality applications may superimpose visual information on camera viewfinder frames. This visual information is typically presented as a layer of text, icons, and general computer generated imagery, whose position on the display is determined by the orientation for the camera device obtained from motion related onboard sensors such as, for example, a magnetometer, or gyroscope, etc.

A mobile augmented reality application may keep its generated imagery aligned closely with real-world features in camera viewfinder frames while maintaining smooth movement. The highest frequency changes are typically rotational in nature, caused by a user panning the camera. At present, if sensors of a handset such as, for example, a magnetometer or gyroscope are used directly to drive movement of imagery, the noise in the sensors may cause jittery movement. The jittery movements may cause the generated imagery (e.g., POIs) associated with the real-world objects to be blurry when shown on a display which may be undesirable to a user.

Currently, the operating system of some handsets may automatically combine sensor(s) reading such as, for example, magnetometer and gyroscope readings to obtain more accurate overall readings. Although this approach may provide satisfactory results over a broad range of lower frequencies, it does not typically remove high frequency noise.

In view of the foregoing drawbacks, it may be desirable to provide an efficient and optimal mechanism of smoothing visual information in augmented reality to users of communication devices.

### BRIEF SUMMARY

A method, apparatus and computer program product are therefore provided for facilitating smooth rendering of augmented reality based in part on utilizing rotational kinematics modeling. In this regard, an example embodiment may utilize a kinematic model based on changes in rotational velocity of a device (e.g., a communication device (e.g., a camera of a communication device)). The rotational velocity of the kinematic model may be changed by the device to bring its yaw value in line with sensor data received from one or more sensors within a small interval of time. The sensor data may include one or more noisy yaw values and the device may smooth the yaw values in a time interval(s) so that a motion of projected objects appears smooth on a display.

The time interval(s) may vary in an inverse manner with the rotational distance that may be traversed by a device (e.g., a camera being panned or rotated). A larger time interval may be utilized such that the velocity may be adjusted before the kinematic model reaches a desired destination (e.g., a destination that the camera may be rotated to). This larger time interval may be sufficient to smooth out sensor noise (e.g., sensor noise of the noisy yaw values). An example embodiment may utilize a smaller time interval to keep the kinematic model responsive to sudden large movements (e.g., rotations of the camera).

In this regard, an example embodiment may allow yaw smoothing that may be synchronized to a screen refresh rate, and may be adjusted to a noise frequency so as to minimize jitter associated with virtual information that may be positioned and displayed via a device (e.g., a camera).

In one example embodiment, a method for facilitating smooth rendering of augmented reality based in part on utilizing rotational kinematics modeling is provided. The method may include determining at least one orientation of a media capturing device capturing one or more real-world objects in a field of view of the media capturing device. The kinematics model may be predefined with data specifying a manner in which to determine one or more orientations of the media capturing device. The method may further include periodically receiving information from one or more sensors. The information may indicate that the orientation is changed to a different orientation of the media capturing device in response to detection of a change in rotational angular velocity of the media capturing device. The method may further include adjusting the data of the kinematics model based in part on the received information from the sensors to estimate a current orientation of the media capturing device.

In another example embodiment, an apparatus for facilitating smooth rendering of augmented reality based in part on utilizing rotational kinematics modeling is provided. The apparatus may include a processor and memory including computer program code. The memory and the computer program code are configured to, with the processor, cause the apparatus to at least perform operations including determining at least one orientation of a media capturing device capturing one or more real-world objects in a field of view of the media capturing device. The kinematics model may be predefined with data specifying a manner in which to determine one or more orientations of the media capturing device. The memory and computer program code are further configured to, with the processor, cause the apparatus to periodically receive information from one or more sensors. The information may indicate that the orientation is changed to a different orientation of the media capturing device in response to detection of a change in rotational angular velocity of the media capturing device. The memory and computer program code are further configured to, with the processor, cause the apparatus to adjust the data of the kinematics model based in part on the received information from the sensors to estimate a current orientation of the media capturing device.

In yet another example embodiment, a computer program product for facilitating smooth rendering of augmented reality based in part on utilizing rotational kinematics modeling is provided. The computer program product includes at least one computer-readable storage medium having computer-executable program code instructions stored therein. The computer-executable program code instructions may include program code instructions configured to determine at least one orientation of a media capturing device capturing one or more real-world objects in a field of view of the media capturing device. The kinematics model may be predefined with data specifying a manner in which to determine one or more orientations of the media capturing device. The program code instructions may also be configured to periodically facilitate receipt of information from one or more sensors. The information may indicate that the orientation is changed to a different orientation of the media capturing device in response to detection of a change in rotational angular velocity of the media capturing device. The program code instructions may also be configured to adjust the data of the kinematics model based in part on the received information from the sensors to estimate a current orientation of the media capturing device.

### BRIEF DESCRIPTION OF THE SEVERAL VIEWS OF THE DRAWINGS

Having thus described some embodiments of the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is a diagram illustrating yaw smoothing of graphical elements based in part on using rotational kinematics according to an example embodiment of the invention; and

FIG. 4 illustrates a flowchart for facilitating smooth rendering of augmented reality based in part on utilizing rotational kinematics modeling according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, orientation may denote placement of an object (e.g., a camera module) in a rotational coordinate system with respect to a fixed point and a reference position. The orientation may be associated with angular position of an object (e.g., a camera module) about a fixed axis (e.g., a y-axis). In this regard, the object may be rotated about the fixed axis, typically parallel to the gravitational field where the object (e.g., a camera module) is located.

As referred to herein, the terms “point of interest(s)” (POI(s)), “virtual information”, “virtual indicia”, “visual indicia”, “visible indicia”, “visual information” and similar terms may be used interchangeably to refer to a point(s) in space (e.g., a geo-coordinate(s) such as, for e.g., longitude, latitude, altitude coordinates) which contains or is associated with some information (e.g., text, audio data, media content such as for example an image(s), picture(s), icon, video data, etc.). The POI(s), virtual information, virtual indicia, visual indicia, visible indicia, or visual information may be marked on a display by a virtual object(s) (e.g., a graphical element(s) such as an icon(s), pictogram(s), etc.).

As referred to herein, yaw may denote a direction, or heading, as an angle from a North direction or another cardinal direction. Additionally, as referred to herein, a yaw value may denote a value of an actual rotation angle.

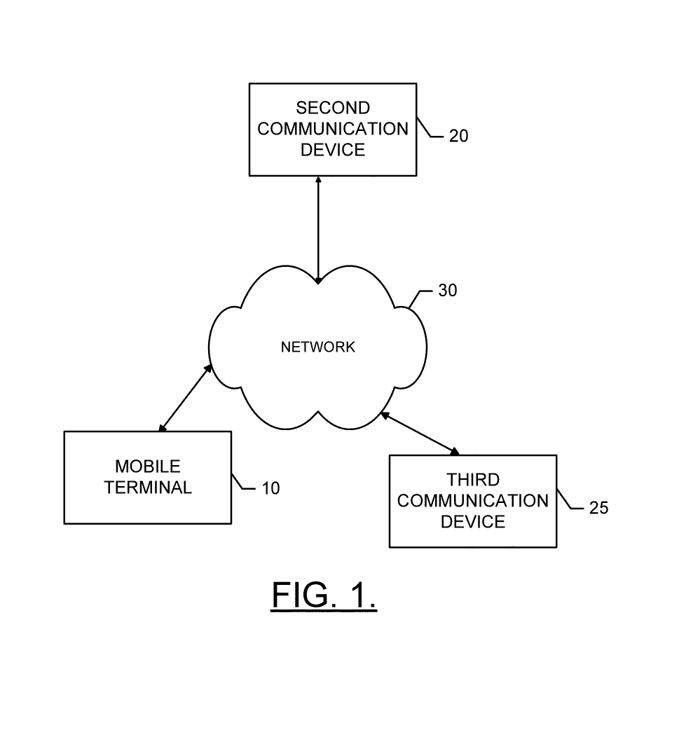

FIG. 1 illustrates a generic system diagram in which a device such as a mobile terminal 10 is shown in an exemplary communication environment. As shown in FIG. 1, an embodiment of a system in accordance with an example embodiment of the invention may include a first communication device (e.g., mobile terminal 10) and a second communication device 20 capable of communication with each other via a network 30. In one embodiment of the invention may further include one or more additional communication devices, one of which is depicted in FIG. 1 as a third communication device 25. In one embodiment, not all systems that employ an embodiment of the invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the invention. Furthermore, devices that are not mobile, such as servers and personal computers may also readily employ an embodiment of the invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all-inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (WiFi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as, for example, personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

In an example embodiment, the second and third communication devices 20 and 25 may be network entities such as servers or the like that are configured to communicate with each other and/or the mobile terminal 10. For instance, in an example embodiment, the second communication device 20 may be a dedicated server (or server bank) associated with a particular information source or service (e.g., a localized augmented reality service, a mapping service, a search service, a media provision service, etc.) or the second communication device 20 may be a backend server associated with one or more other functions or services. As such, the second communication device 20 may represent a potential host for a plurality of different services or information sources. In one embodiment, the functionality of the second communication device 20 is provided by hardware and/or software components configured to operate in accordance with known techniques for the provision of information to users of communication devices. However, at least some of the functionality provided by the second communication device 20 is information provided in accordance with example an embodiment of the invention.

In an example embodiment, the second communication device 20 may host an apparatus for providing a localized augmented reality service and/or may host a provision service that provides information (e.g., panoramic images) to a device (e.g., mobile terminal 10) practicing an embodiment of the invention. The localized augmented reality service may provide items of virtual information about an environment displayed in a camera view of a device (e.g., mobile terminal 10) and the real world objects in the environment.

The third communication device 25 may also be a server providing a number of functions or associations with various information sources and services (e.g., a localized virtual/augmented reality service, a mapping service, a search service, a media provision service, etc.). In this regard, the third communication device 25 may host an apparatus for providing virtual/augmented reality information to the second communication device 20 to enable the second communication device to provide the virtual/augmented reality information to a device (e.g., the mobile terminal 10) practicing an embodiment of the invention. The virtual/augmented reality information provided by the third communication device 25 to the second communication device 20 may provide information about an environment displayed in a camera view of a device (e.g., mobile terminal 10) and the objects in the environment.

As such, in one embodiment, the mobile terminal 10 may itself perform an example embodiment. In another embodiment, the second and third communication devices 20 and 25 may facilitate (e.g., by the provision of augmented reality information) operation of an example embodiment at another device (e.g., the mobile terminal 10). In still one other example embodiment, the second communication device 20 and the third communication device 25 may not be included at all.

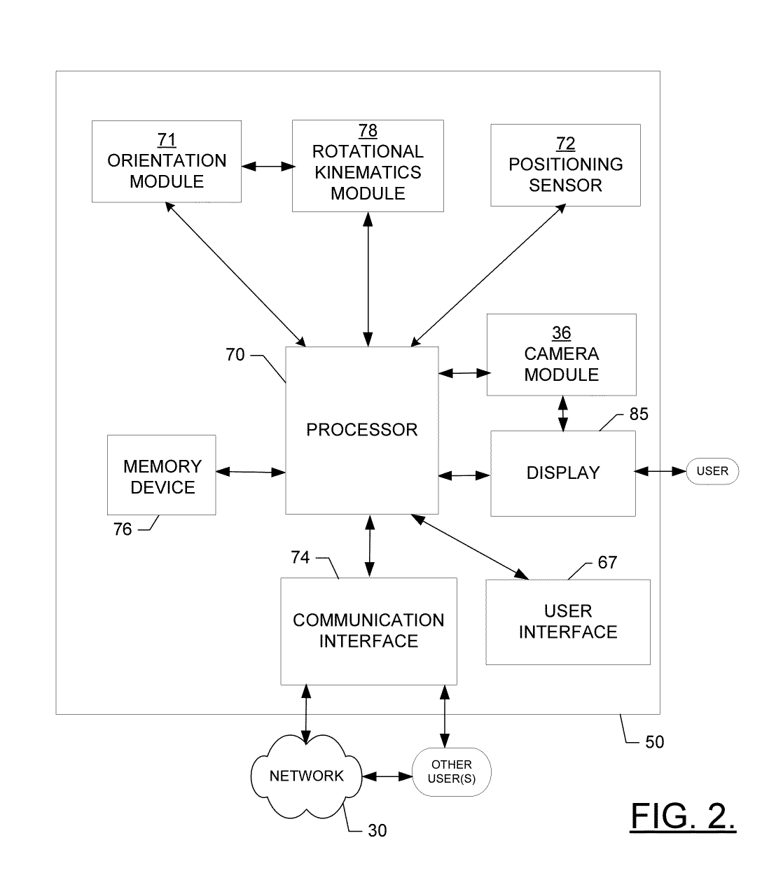

FIG. 2 illustrates a schematic block diagram of an apparatus for facilitating smooth rendering of augmented reality based in part on utilizing rotational kinematics modeling according to an example embodiment of the invention. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, an embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, an orientation module 71, a rotational kinematics module 78, a positioning sensor 72 and a camera module 36. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., pictures, videos, etc.).

The memory device 76 may store geo-coded information that may be associated with location information corresponding to coordinates such as, for example, latitude, longitude and/or altitude coordinates of real-world objects. The geo-coded information may be evaluated by the processor 70 and data associated with the geo-coded information may be provided to a camera view of a display. In an example embodiment, the processor 70 may provide the information associated with the geo-coded information to the camera view of the display, in response to determining that the location of the real-world objects shown on the camera view of the display correspond to the location information of the geo-coded information.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, such as a browser, augmented reality (AR) browser, Web browser or the like. In this regard, the connectivity program may enable the apparatus 50 to transmit and receive Web content, such as for example location-based content or any other suitable content, according to a Wireless Application Protocol (WAP), for example. It should be pointed out that the AR browser may be a user interface that facilitates navigation of objects in a view of a physical real-world environment with information such as, for example, one or more graphical elements that are added, augmented or altered in some fashion by providing data about the surrounding real world objects. The graphical elements may, but need not, be viewed as on top of the real world view. The AR browser may be utilized by the processor 70 to facilitate execution of one or more augmented reality applications. It should be pointed out that the processor 70 may also be in communication with a display 85 and may instruct the display to illustrate any suitable information, data, content (e.g., media content) or the like.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

The apparatus 50 includes a media capturing element, such as camera module 36. The camera module 36 may include a camera, video and/or audio module, in communication with the processor 70 and the display 85. The camera module 36 may be any means for capturing an image, video and/or audio for storage, display or transmission. For example, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device (e.g., memory device 76) of the apparatus 50 stores instructions for execution by the processor 70 in the form of software necessary to create a digital image file from a captured image. In an example embodiment, the camera module 36 may further include a processing element such as a co-processor which assists the processor 70 in processing image data and an encoder and/or decoder for compressing and/or decompressing image data. The encoder and/or decoder may encode and/or decode according to a Joint Photographic Experts Group, (JPEG) standard format or another like format. In some cases, the camera module 36 may provide live image data to the display 85. In this regard, the camera module 36 may facilitate or provide a camera view to the display 85 to show live image data, still image data, video data, or any other suitable data. Moreover, in an example embodiment, the display 85 may be located on one side of the apparatus 50 and the camera module 36 may include a lens positioned on the opposite side of the apparatus 50 with respect to the display 85 to enable the camera module 36 to capture images on one side of the apparatus 50 and present a view of such images to the user positioned on the other side of the apparatus 50.

In addition, the apparatus 50 may include a positioning sensor 72. The positioning sensor 72 may include, for example, a global positioning system (GPS) sensor, an assisted global positioning system (Assisted-GPS) sensor, a Bluetooth (BT)-GPS mouse, other GPS or positioning receivers or the like. However, in one example embodiment, the positioning sensor 72 may include a pedometer or inertial sensor. In this regard, the positioning sensor 72 may be capable of determining a location of the apparatus 50, such as, for example, longitudinal and latitudinal directions of the apparatus 50, or a position relative to a reference point such as a destination or start point. The positioning sensor 72 may also be capable of determining an altitude of the apparatus 50 and use the altitude information in determining the location of the apparatus 50. Information from the positioning sensor 72 may then be communicated to a memory of the apparatus 50 or to another memory device to be stored as a position history or location information. In this regard, for example, the position history may define a series of data points corresponding to positions of the apparatus 50 at respective times. Various events or activities of the apparatus 50 may also be recorded in association with position history or location information provided by the positioning sensor 72.

In an example embodiment, the apparatus 50 may further include (or be in communication with) an orientation module 71. The orientation module 71 may be any means such as a device or circuitry embodied in either hardware or a combination of hardware and software that is configured to determine the orientation of apparatus 50 and/or of the field of view of the camera module 36 of the apparatus 50. The orientation module 71 may be in communication with the rotational kinematics module 78.

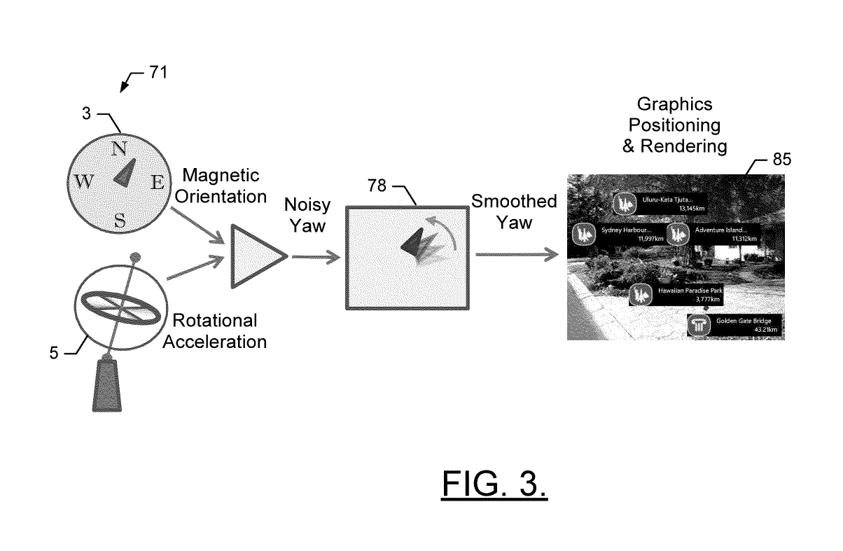

The orientation module 71 may be configured to determine the orientation of apparatus 50 and/or the camera module 36 relative to a reference. In some cases, the reference may be a particular direction, such as North or another cardinal direction. However, other references could also be employed. As such, in one embodiment, the orientation module 71 may include a compass (e.g., compass 3 of FIG. 3) or other orientation sensor (e.g., gyroscope 5 of FIG. 3) configured to determine the heading of the apparatus 50 or direction that the lens of the camera module 36 is pointing. The direction or heading may be determined in terms of degrees (e.g., 0 to 360 degrees) or radians offset from the reference. In some cases, the reference may be fixed (e.g., a fixed directional reference), while in other cases, the reference may be a reference of opportunity such as a prominent feature in an image captured by the camera module or simply an initial orientation. In one embodiment, the orientation module 71 may include an electronic compass, a horizon sensor, gravity sensor, accelerometer, gyroscope, magnetometer and/or the like or any other sensor(s) that may be useful in determining orientation information.

In an example embodiment, the processor 70 may be embodied as, include or otherwise control a rotational kinematics module 78. As such, in one embodiment, the processor 70 may be said to cause, direct or control the execution or occurrence of the various functions attributed to the rotational kinematics module 78, as described herein. The rotational kinematics module 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the rotational kinematics module, as described herein. Thus, in examples in which software is employed, a device or circuitry (e.g., the processor 70 in one example) executing the software forms the structure associated with such means.

In an example embodiment, the rotational kinematics module 78 may implement a defined kinematics model that may be utilized to determine or estimate the rotational motion of the camera module 36. For instance, the rotational kinematics module 78 may utilize a kinematics model to follow or track the rotational velocity about the an axis (e.g., the y axis (e.g., the vertical axis)) of the camera module 36 and the rotational kinematics module 78 may continue to detect rotations following the same velocity (e.g., the rotational velocity) until the rotational kinematics module 78 detects a change in angular velocity of the camera module 36. The rotational kinematics module 78 may detect a change in angular velocity of the camera module 36 in response to receiving periodic readings such as, for example, sensor data (e.g., orientation information) from one or more sensors of the orientation module 71. In this regard, the rotational kinematics module 78 may read or analyze sensor orientation information and may make adjustments to the kinematics model based on the sensor orientation information received from one or more sensors of the orientation module 71.

In this regard, in an instance in which the camera module 36 moves about its vertical axis (e.g., the y axis) continuously, the rotational kinematics module 78 may estimate the rotational velocity of the camera module 36. The estimate of the rotational velocity of the camera module 36 may be zero in instances in which the camera module 36 is stationary. On the other hand, the estimate of the rotational velocity, by the rotational kinematics module 78, of the camera module 36 may be denoted by positive floating values in instances in which the camera module 36 is moving about the vertical axis (e.g., the y axis). As an example, the camera module 36 may be moved about the vertical axis in response to a user of the apparatus 50 moving (e.g., turning from side-to-side, panning) the camera module 36.

The rotational kinematics module 78 may estimate rotational velocity of the camera module 36 that is increased counter-clockwise and/or decreased counter-clockwise. Additionally or alternatively, the rotational kinematics module 78 may estimate rotational velocity of the camera module 36 that is increased clockwise and/or decreased clockwise. To estimate the rotational velocity of the camera module 36, the rotational kinematics module 36 may utilize a kinematics model which may describe or designate the motion of a body (e.g., apparatus 50, camera module 36) of a particle but may not necessarily consider, at least not directly within the designated (e.g., predefined) kinematics model, knowledge (e.g., explicit knowledge) or understanding of forces (e.g., Newtonian forces) like forces that modify (e.g., a user of the apparatus 50 turning side-to-side, panning with the apparatus 50) the velocity of the body (e.g., apparatus 50, camera module 36).

The rotational kinematics module 78 may estimate the rotational velocity of the camera module 36 and/or the apparatus 50 by determining the difference between a previously detected position, the current estimated angular position of the camera module 36 and/or apparatus 50 and may determine the estimate of the rotational velocity as well as the time it took for the position of the camera module 36 and/or the apparatus 50 to change. In this regard, the rotational kinematics module 36 may use kinematics information of the kinematics model to estimate or determine a next predicted position of the camera module 36 and/or apparatus 50 in terms of rotational position (e.g., the next predicted orientation of the camera module 36 and/or apparatus 50). Additionally, the rotational kinematics module 78 may analyze data from one or more sensors of the orientation module 71 periodically to adjust estimates of predicted positions/orientations of the camera module 36 and/or apparatus 50. In this manner, the rotational kinematics module 78 may utilize a dual approach to determining orientation information indicative or descriptive of the orientation of the camera module 36 and/or apparatus 50 (e.g., mobile terminal 10) (relative to a reference) associated with a field of view (e.g., a field of view of the camera module 36).

For example, the rotational kinematics module 78 may utilize a designated kinematics model which estimates or determines the changes of the orientation of the camera module 36 and/or apparatus 50. Additionally, the rotational kinematics module 78 may adjust the estimate based in part on one or more periodic sensor readings indicating the orientation instead of exclusively using continuously captured sensor readings. By utilizing this approach, jitter and noisy sensor readings associated with orientation information may be reduced and visual information (e.g., graphical elements (e.g., text, icons, POIs, etc.) that may be superimposed on a display depicting real-world objects may be smoother and more accurate.

As described above, the rotational kinematics module 78 may utilize a kinematic model to estimate the perpetual changes in the angular velocity of the camera module 36 and/or apparatus 50 in order to achieve a continuous fluid motion of the visual information (also referred to herein as virtual information) that may be superimposed on a display (e.g., display 85). The rotational velocity of the kinematics model may be changed by the rotational kinematics module 78, to bring a yaw value(s) (e.g., the value of the actual rotation angle) of the kinematics model in line with sensor data (e.g., sensor yaw data) within a small interval of time. The sensor data may be received by the rotational kinematics module 78 from one or more sensors of an orientation module 71, as described above.

The rotational kinematics module 78 may vary the time interval in an inverse manner based in part on the rotational distance that may be traversed by the camera module 36 and/or apparatus 50. In this regard, the rotational kinematics module 78 may utilize a larger time interval in an instance in which the velocity (e.g., rotational velocity) is adjusted by the rotational kinematics module 78 before the kinematics model reaches a desired destination (e.g., a destination in which a user of the apparatus 50 pans the camera module 36). This larger time interval may be just sufficient for the rotational kinematics module 78 to smooth out sensor noise. The rotational kinematics module 78 also utilize a smaller time interval keep the kinematics model responsive to sudden large movements, which may not necessarily be smooth in every instance, as described more fully below.

In an example embodiment, in an instance in which the rotational kinematics module 78 detects or estimates a slow change (e.g., slow movement) in rotational velocity of the camera module 36, the rotational kinematics module 78 may utilize the larger smoothing interval (e.g., a larger/longer time interval or cycle) in which the rotational kinematics module 78 may take several cycles to fully react to changes in rotational velocity. For example, the rotational kinematics module 78 may process data received from one or more sensors of the orientation module 71 over a number of cycles (e.g., three to four cycles, etc.). The rotational kinematics module 78 may utilize the larger smoothing interval in response to detecting slow changes in rotational velocity so that visual information may be provided to a display (e.g., display 85) of the camera module 36 smoothly with minimal jitter and noise since a user of the apparatus 50 may desire to view the visual information superimposed on corresponding captured real-world objects with a high level of accuracy given that the user is moving the apparatus 50 slowly. In this regard, since the user may be rotating/moving the apparatus 50 slowly, the user may not perceive any delay between sensor changes and visual information (e.g., POIs, etc.) provided to the display (e.g., display 85) of the camera module 36.

On the other hand, the rotational kinematics module 78 may utilize the smaller smoothing interval (e.g., a shorter time interval or cycle) in an instance in which the rotational kinematics module 78 detects fast, abrupt changes in rotational velocity (e.g., movements) of the camera module 36. In this regard, the rotational kinematics module 78 may process data obtained from one or more sensors of the orientation module 71 quickly (e.g., in substantially one cycle or any other suitable number of cycles). In this regard, the rotational kinematics module 78 may estimate an orientation of the camera module 36 in a swift manner in response to the rapid change in rotational velocity of the camera module 36. As such, visible information detected in the field of view of the camera module 36 that may be shown on the display (e.g., display 85) of the camera module 36 may, but need not, appear jittery, in some instances, in response to the rapid changes in rotational velocity of the camera module 36. In some instances, the jitter associated with rapid changes in rotational velocity of the camera module 36 may not cause user dissatisfaction since the user may not be currently evaluating the visual information captured in the field of view of the camera module 36 while swiftly moving or rotating the camera module 36.

In an instance in which, the rotational kinematics module 78 detects rapid changes in rotational velocity of the camera module 36, the rotational kinematics module 78 may enable the kinematics model to converge to the new direction corresponding to captured objects in the physical real-world environment that the user moved the camera module 36 to in a quick manner.

In an example embodiment, the rotational kinematics module 78 may receive sensor data (e.g., orientation information (e.g., yaw values)) from one or more sensors (e.g., compass 3 of FIG. 3, gyroscope 5 of FIG. 3) of the orientation module 71 at the same frequency or rate (e.g., at 30 frames per second, at 60 frames per second, etc.) in response to the sensors measuring the data. Although the sensor data may be received at the same rate, in an instance in which the rotational kinematics module 78 utilizes the larger smoothing interval, the rotational kinematics module 78 may divide or propagate the sensor data received at the same frequency, among different cycles (e.g., three cycles, four cycles, etc.).

On the other hand, in an instance in which the rotational kinematics module 78 utilizes the shorter smoothing time interval, the rotational kinematics module 78 may process the received sensor data in a swifter manner such as, for example, in one cycle (or substantially in one cycle). In this regard, the orientation specified by the sensors of the orientation module 71 may be processed very quickly.

To provide optimal smoothing of movement on the display (e.g., display 85) of the camera module 36, the update interval (also referred to herein as update time interval) may be closely tied to or associated with a redraw rate of a corresponding rendering code. The largest smoothing interval may be designated by the rotational kinetics module 78 to be longer than the inverse of lowest frequency of noise in the sensor data received from one or more sensors of the orientation module 71. The larger time interval may be several times larger than the update interval. The smallest smoothing interval may be designated by the rotational kinetics module 78 to be at least as large as the update interval and may be adjusted to produce a good user experience for rapid rotational movements. A discrepancy-to-interval mapping function utilized by the rotational kinematic module 78 may be either continuous or discrete.

Referring now to FIG. 3, a diagram illustrating smoothed yaw data being utilized to render virtual information over captured real-world objects is provided according to an example embodiment. In the example embodiment of FIG. 3, the rotational kinematics module 78 may utilize a kinematics model to estimate the orientation of a field of view of a camera module 36. Periodically, the rotational kinematics module 78 may receive sensor data (e.g., sensor yaw data utilized to identify the orientation of the camera module 36) from one or more sensors (e.g., a compass 3, a gyroscope 5) of an orientation module 71. The sensor data received by the rotational kinematics module 78 from the one or more sensors of the orientation module 71 may be noisy (e.g., noisy yaw data). In this regard, the rotational kinematics module 78 may process the noisy sensor data to remove the noise and jitter to enable smooth rendering of one or more items of virtual information associated with the noisy sensor data.

For instance, the rotational kinematics module 78 may smooth the noisy yaw data and provide (e.g., via processor 70) the smoothed yaw data to a display (e.g., display 85) of the camera module 36. In this regard, the rotational kinematics module 78 may position and render the data associated with the smoothed yaw data over corresponding real-world objects captured by the camera module 36 that may be displayed in the display (e.g., display 85) of the camera module 36.

In the example embodiment of FIG. 3, rotational motion may be restricted by the rotational kinematics module 78 about the y-axis, the axis of height direction, and in this regard the rotational kinematics module 78 may discard sensor data obtained by the sensors (e.g., compass 3, gyroscope 5) of the orientation module 71 in other axis directions (e.g., an x axis direction, a z axis direction).

The rotational kinematics module 78 may utilize several parameters to control the kinematics model. One of the parameters may be the interval at which a smoothed yaw value is updated, as described above. For instance, a larger smoothing interval may be used by the rotational kinematics module 78 for small discrepancies between sensor and model yaw values. On the other hand, the smaller smoothing interval may be utilized by the rotational kinematics module 78 for large discrepancies between sensor and model yaw values. In this regard, the rotational kinematics module 78 may utilize a function that maps the discrepancy (e.g., −π to +π radians) between sensor and model yaw values to a smoothing interval.

Other parameters utilized by the rotational kinematics module 78 are as follows in which:

Tᵤ is the update time interval for the kinematics model.

Yₖ is the yaw value in the kinematics model.

Yₙ is the noisy yaw value from the sensors.

F( ) is the function mapping yaw discrepancy to smoothing interval.

The rotational kinematics module 78 may utilize the parameters in part to compute the following:

Yaw discrepancy, Y_{Δ}=Yₙ−Yₖ.

Smoothing time interval, Tₛ=F(Y_{Δ}).

Kinematic rotational velocity, Vₖ=Y_{Δ}/Tₛ.

Updated yaw, Yₖ′=Yₖ+Vₖ*Tᵤ.

By way of illustration and not of limitation, consider a non-limiting example embodiment in which the rotational kinematics module 78 may calculate a discrete F( ) where the domain is in radians, in which:

$$F ( Y ) ≡ \begin{matrix}0.0 \leq \vert Y \vert \leq 3.0 & -> & 4 * {T}_{u} \\ \vert Y \vert > 3.0 & -> & 1.05 * {T}_{u}\end{matrix}$$

In the above example, Y (also referred to herein as Y_{Δ}) (e.g., Y_{Δ}=Yₙ−Yₖ) may denote the yaw discrepancy of a camera module 36 in radians (e.g., a number of radians). The yaw discrepancy may indicate how far a user turned the camera module 36 since a previous estimated or determined value. For instance, the yaw discrepancy (Y_{Δ}) may denote the difference between what the kinematics model indicates as the direction in which the camera module 36 is pointed and what one or more sensors of the orientation module 71 indicates as the direction in which the camera module 36 is pointed. In this example, the rotational kinematics module 78 may change the kinematics model such that the orientation of the camera module 36 may correspond to the direction indicated by one or more of the sensors of the orientation module 71. In order to determine a change in velocity (e.g., rotational velocity) of the camera module 36, the rotational kinematics module 78 may divide the yaw discrepancy by a time interval. For instance, the rotational kinematics module 78 may divide the yaw discrepancy by the smoothing time interval to determine the rotational velocity, Vₖ, in radians per second for the kinematics model.

As such, in this example embodiment, in response to the rotational kinematics module 78 determining that a number of radians is between 0 and 3, the rotational kinematics module 78 may smooth out noisy yaw data (e.g., noisy sensor data) over 4 time intervals, denoted by 4*Tᵤ, in which Tᵤ indicates the time interval (e.g., 30 frames per second, 60 frames per second, etc.) in which the rotational kinetics module 78 may update the kinematics model. As such, in an instance in which the change in yaw discrepancy of a camera module 36 in radians is small such as, for example, between 0 to 3 radians in this example, the rotational kinematics module 78 may utilize the smaller smoothing time interval to smooth yaw data (e.g., noisy yaw data received from one or more sensors). The rotational kinematics module 78 may enable virtual indicia associated with corresponding captured real-world objects to be updated and provided to a display (e.g., display 85) of the camera module 36. One or more items of the virtual indicia may be superimposed over one or more of the corresponding real-world objects on the display. In one example embodiment, in an instance in which the change in yaw discrepancy of a camera module 36 in radians is equal to or below a predefined threshold (e.g., 3 radians), the rotational kinematics module 78 may utilize the smaller smoothing time interval to smooth yaw data (e.g., noisy yaw data received from one or more sensors).

On the other hand, in response to the rotational kinematics module 78 detecting that the change in rotational velocity of the camera module 36 is moved such that the yaw discrepancy (Y_{Δ}) is greater than 3 (e.g., exceeds the predefined threshold), the rotational kinematics module 78 may smooth out noisy yaw data substantially or approximately within one cycle, denoted by 1.05*Tᵤ, as an example in which Tᵤ indicates the time interval for updating the kinematics module, as described above. The detection by the rotational kinematics module 78 of the number of radians being greater than 3 may denote a quick abrupt change in rotational velocity of the camera module 36 and as such, in this example, the rotational kinematics module 78 may utilize the smaller smoothing time interval. The smaller smoothing time interval may be utilized by the rotational kinematics module 78 to update the kinematics model based on the received sensor data (e.g., noisy yaw data) from one or more sensors of the orientation module 71. The sensor data (e.g., noisy yaw data) may be smoothed substantially over one cycle by the rotational kinematics module 78 to enable the orientation of the field of view of the camera module 36 to be updated in a quick manner. In this regard, the rotational kinematics module 78 may enable virtual indicia associated with captured real-world objects to be updated and provided to a display (e.g., display 85) of the camera module 36 in a fast manner. One or more items of the virtual indicia may be superimposed over one or more of the corresponding real-world objects on the display.

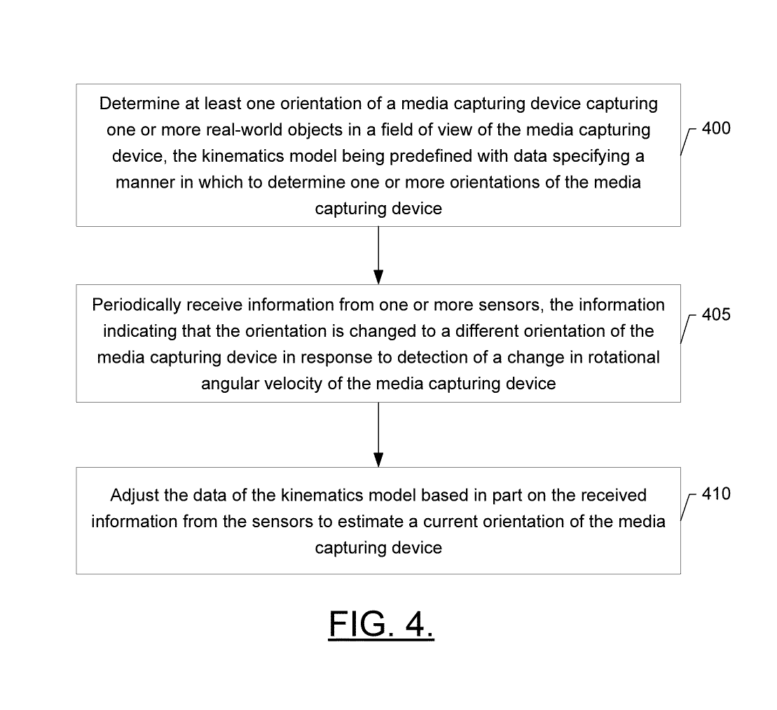

Referring now to FIG. 4, an example embodiment of a flowchart for facilitating smooth rendering of augmented reality based in part on utilizing rotational kinematics modeling is provided. At operation 400, an apparatus 50 may include means, such as the rotational kinematics module 78, the processor 70 and/or the like, for determining at least one orientation of a media capturing device (e.g., camera module 36) capturing one or more real-world objects in a field of view of the media capturing device. The kinematics model may be predefined with data specifying a manner in which to determine one or more orientations of the media capturing device.

At operation 405, the apparatus 50 may include means, such as the rotational kinematics module 78, the processor 70 and/or the like for, periodically receiving information from one or more sensors (e.g., compass 3, gyroscope 5 of the orientation module 71). The information may indicate that the orientation is changed to a different orientation of the media capturing device in response to detection of a change in rotational angular velocity of the media capturing device. At operation 410, the apparatus 50 may include means, such as the rotational kinematics module 78, the processor 70 and/or the like for, adjusting the data of the kinematics model based in part on the received information from the sensors to estimate a current orientation of the media capturing device (e.g., camera module 36).

It should be pointed out that FIG. 4 is a flowchart of a system, method and computer program product according to an example embodiment of the invention. It will be understood that each block of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76) and executed by a processor (e.g., processor 70, rotational kinematics module 78). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In an example embodiment, an apparatus for performing the method of FIG. 4 above may comprise a processor (e.g., the processor 70, rotational kinematics module 78) configured to perform some or each of the operations (400-410) described above. The processor may, for example, be configured to perform the operations (400-410) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (400-410) may comprise, for example, the processor 70 (e.g., as means for performing any of the operations described above), the rotational kinematics module 78 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining at least one orientation of a media capturing device capturing one or more real-world objects in a field of view of the media capturing device, the kinematics model being predefined with data specifying a manner in which to determine one or more orientations of the media capturing device;
periodically receiving information from one or more sensors, the information indicating that the orientation is changed to a different orientation of the media capturing device in response to detection of a change in rotational angular velocity of the media capturing device; and
adjusting, via the processor, the data of the kinematics model based in part on the received information from the sensors to estimate a current orientation of the media capturing device.

2. The method of claim 1, wherein the received information comprises noisy yaw data and the method further comprises:
smoothing the noisy data, in an update time interval, which removes jitter to obtain smoothed yaw data.

3. The method of claim 2, further comprising:
utilizing the smoothed yaw data to enable display of one or more items of virtual information superimposed on one or more corresponding captured real-world objects.

4. The method of claim 1, wherein the rotational angular velocity is detected about a y-axis which is an axis in a height direction of the media capturing device.

5. The method of claim 1, wherein the update time interval comprises an update time period designated for updating the kinematics model in response to the detection of the change in rotational angular velocity.

6. The method of claim 2, further comprising:
performing the smoothing of the noisy data during a designated smoothing time interval comprising a time period that is determined based in part on a yaw discrepancy between a yaw value in the kinematics model and a noisy yaw value of the noisy yaw data received from the sensors.

7. The method of claim 6, further comprising:
determining that the time period of the smoothing time interval comprises a small time interval, relative to a designated larger time interval, in response to detecting that a change in rotational distance is equal to or below a predefined threshold, the rotational distance is associated with a change in rotational velocity of the media capturing device; and
processing one or more items of received information from the sensors over a plurality of cycles in response to determining that the rotational distance is below the predefined threshold.

8. The method of claim 6, further comprising:
determining that the time period of the smoothing time interval comprises a large time interval, relative to a designated small time interval, in response to detecting that a change in distance of rotational velocity exceeds the predefined threshold.

9. The method of claim 8, further comprising:
processing one or more items of the received information from the sensors in substantially one cycle in response to determining that the rotational distance exceeds the predefined threshold.

10. An apparatus comprising:
at least one processor; and
at least one memory including computer program code, the at least one memory and the computer program code configured to, with the at least one processor, cause the apparatus to perform at least the following:
determine at least one orientation of a media capturing device capturing one or more real-world objects in a field of view of the media capturing device, the kinematics model being predefined with data specifying a manner in which to determine one or more orientations of the media capturing device;
periodically receive information from one or more sensors, the information indicating that the orientation is changed to a different orientation of the media capturing device in response to detection of a change in rotational angular velocity of the media capturing device; and
adjust the data of the kinematics model based in part on the received information from the sensors to estimate a current orientation of the media capturing device.

11. The apparatus of claim 10, wherein the received information comprises noisy yaw data and the memory and computer program code are configured to, with the processor, cause the apparatus to:
smooth the noisy data, in an update time interval, which removes jitter to obtain smoothed yaw data.

12. The apparatus of claim 11, wherein the memory and computer program code are configured to, with the processor, cause the apparatus to:
utilize the smoothed yaw data to enable display of one or more items of virtual information superimposed on one or more corresponding captured real-world objects.

13. The apparatus of claim 10, wherein the rotational angular velocity is detected about a y-axis which is an axis in a height direction of the media capturing device.

14. The apparatus of claim 10, wherein the update time interval comprises an update time period designated for updating the kinematics model in response to the detection of the change in rotational angular velocity.

15. The apparatus of claim 11, wherein the memory and computer program code are configured to, with the processor, cause the apparatus to:
perform the smoothing of the noisy data during a designated smoothing time interval comprising a time period that is determined based in part on a yaw discrepancy between a yaw value in the kinematics model and a noisy yaw value of the noisy yaw data received from the sensors.

16. The apparatus of claim 15, wherein the memory and computer program code are configured to, with the processor, cause the apparatus to:
determine that the time period of the smoothing time interval comprises a small time interval, relative to a designated larger time interval, in response to detecting that a change in rotational distance is equal to or below a predefined threshold, the rotational distance is associated with a change in rotational velocity of the media capturing device; and
process one or more items of received information from the sensors over a plurality of cycles in response to determining that the rotational distance is below the predefined threshold.

17. The apparatus of claim 15, wherein the memory and computer program code are configured to, with the processor, cause the apparatus to:
determine that the time period of the smoothing time interval comprises a large time interval, relative to a designated small time interval, in response to detecting that a change in distance of rotational velocity exceeds the predefined threshold.

18. The apparatus of claim 17, wherein the memory and computer program code are configured to, with the processor, cause the apparatus to:
process one or more items of the received information from the sensors in substantially one cycle in response to determining that the rotational distance exceeds the predefined threshold.

19. A computer program product comprising at least one non-transitory computer-readable storage medium having computer-readable program code portions stored therein, the computer-readable program code portions comprising:
program code instructions configured to determine at least one orientation of a media capturing device capturing one or more real-world objects in a field of view of the media capturing device, the kinematics model being predefined with data specifying a manner in which to determine one or more orientations of the media capturing device;
program code instructions configured to periodically facilitate receipt of information from one or more sensors, the information indicating that the orientation is changed to a different orientation of the media capturing device in response to detection of a change in rotational angular velocity of the media capturing device; and
program code instructions configured to adjust the data of the kinematics model based in part on the received information from the sensors to estimate a current orientation of the media capturing device.

20. The computer program product of claim 19, wherein the received information comprises noisy yaw data and the computer program product further comprises:
program code instructions configured to smooth the noisy data, in an update time interval, which removes jitter to obtain smoothed yaw data.
